(19) United States
(12) Patent Application Publication
(10) Pub. No.: US 2019/0241037 A1
(43) Pub. Date: Aug. 8, 2019

(54) GROUND VEHICLE

(71) Applicant: Orbis Wheels, Inc., Mill Valley, CA (US)

(72) Inventors: Marcus G. Hays, San Rafael, CA (US); Scott Streeter, Santa Rosa, CA (US)

(21) Appl. No.: 16/269,421

(22) Filed: Feb. 6, 2019

Related U.S. Application Data
(60) Provisional application No. 62/627,065, filed on Feb. 6, 2018.

(51) Int. Cl. B60G 17/00; B60G 7/00; B60G 3/14; B60B 19/00; B62D 55/08; B62D 55/02; B60G 17/052; B60G 17/04

(52) U.S. Cl. CPC B60G 17/00; B60G 7/001; B60G 3/14; B60B 19/00; B62D 55/08; B62D 55/02; B60G 2202/152; B60G 17/04; B60G 2200/132; B60G 2300/32; B60G 2300/40; B60G 2202/15; B60G 17/052

(57) ABSTRACT

A ground vehicle may include a platform and a swing arm that may be rotatably coupled to the platform. The swing arm may be configured to move from a first position to a second position by rotating the swing arm about a pivot point on the side of the platform. The pivot point may correspond to where a proximal end of the swing arm couples to the side of the platform. The swing arm may also be configured to move from either the first position or the second position to a third position by actuating the swing arm from the pivot point such that a distal end of the swing arm moves away from the platform to broaden a wheelbase of the ground vehicle. The ground vehicle may also include a centerless wheel assembly coupled to the swing arm.

### CROSS-REFERENCE TO RELATED APPLICATION

This application claims priority to and the benefit of U.S. Patent Application No. 62/627,065, entitled GROUND VEHICLE, which was filed on Feb. 6, 2018, which is hereby incorporated by reference in its entirety.

### FIELD

The embodiments discussed in the present disclosure relate to various ground vehicle assemblies.

### BACKGROUND

Some ground vehicles have been developed to traverse various surfaces and/or terrain. Additionally, some ground vehicles may have a fixed wheelbase which may make it difficult to traverse some surfaces and/or terrain.

The subject matter claimed in the present disclosure is not limited to embodiments that solve any disadvantages or that operate only in environments such as those described above. Rather, this background is only provided to illustrate one example technology area where some embodiments described may be practiced.

### SUMMARY

The present disclosure may relate to various ground vehicle assemblies. The ground vehicle assemblies may include a platform, one or more swing arm assemblies coupled to the platform at a proximal end, and one or more centerless wheel assemblies coupled to the one or more swing arm assemblies at a distal end.

One aspect of the present disclosure includes a platform that may act as a base, chassis, frame, and/or structure for the ground vehicle. Advantageously, the ground vehicle may be configured such that the platform remains substantially level during use of the ground vehicle. For example, the ground vehicle may be configured such that the platform remains substantially level even when the ground vehicle is driven on a surface such as rough terrain. In addition, the platform may be configured such that the platform may yaw, pitch, and/or roll. For example, the platform may be coupled to one or more swing arm assemblies such that that the movement of the one or more swing arm assemblies may cause the platform to yaw, pitch, and/or roll. This may be accomplished using swing arm assemblies that are independently moveable in multiple directions, allowing the ground vehicle to be responsive to the ground surface and variations thereof. The platform may be sized and configured to transport items of various sizes, facilitate stacking of multiple ground vehicles on top of one another, improve aerodynamics and fuel efficiency and/or power savings, improve stealth, and accommodate items such as instruments, tools, and other devices.

In an example embodiment, the platform may be used to accommodate instruments, tools, and other devices that may be desirable to be kept stable and/or substantially level during use. In another example embodiment, the platform may be configured such that the platform may yaw, pitch, and/or roll in order to reduce the likelihood of tipping, promote efficient cornering, and/or avoid obstructions. In yet another example embodiment, the platform may contain one or more cavities within which components including batteries, generators, fuel tanks, GPS instruments, and other devices and components may be located. In an example embodiment, one or more ground vehicles may be configured to stack on top of one another to facilitate transport and/or deployment.

Another aspect of the present disclosure includes one or more swing arm assemblies that may be rotatably coupled to the one or more platform sides. The one or more swing arm assemblies may be configured to rotate such that the clearance between platform and the surface and/or the terrain being traversed by the ground vehicle is increased, remains substantially the same, or is decreased. In addition, the one or more swing arm assemblies may be configured to rotate at various angles measured from a plane substantially parallel to the top surface of the platform. The angle of rotation of the one or more swing arm assemblies, as measured from the plane substantially parallel to the top surface of the platform, may depend on the location of the coupling to the platform. Additionally, the one or more swing arm assemblies may be configured to move in a plane that is perpendicular to a plane that is substantially parallel to the one or more platform sides, effectively narrowing or widening a width of a wheelbase of the ground vehicle. The one or more swing arms assemblies may be configured to rotate in a plane that is perpendicular from a plane that is substantially parallel to the one or more platform sides, effectively changing the camber of the one or more centerless wheel assemblies. The one or more swing arm assemblies may be configured such that the swing arm assemblies and the adjoining centerless wheel assemblies may be located outside of the footprint of the platform, allowing the one or more swing arm assemblies to lower the platform until it comes into contact with the ground or other surface. The one or more swing arm assemblies may also be configured to raise the platform. For example, the one or more swing arm assemblies may also be configured to raise the platform above one or more obstructions or upward from a surface. In addition, the one or more swing arm assemblies may be configured to remain stationary during use of the ground vehicle.

Additionally, the one or more swing arm assemblies may be configured to operate independently of any other of the one or more swing arm assemblies in such a way that the platform remains substantially level while traversing various surfaces and/or terrains. The one or more swing arm assemblies may incorporate components such as gears, belts, hydraulics, and/or pneumatics, etc.

In an example embodiment, the one or more swing arms may be configured to rotate between about zero degrees and about three hundred and sixty degrees as measured from the plane substantially parallel to the top surface of the platform. In another example embodiment, the one or more swing arm assemblies may be configured to rotate and move the platform in such a way that the center of mass of the ground vehicle is shifted in order to reduce the likelihood of tipping, increase efficiency of turning and/or cornering, avoid obstructions, retaining chattel upon the top surface of the ground vehicle when cornering, etc. In yet another example embodiment, the one or more swing arm assemblies may be adjusted according to the grade and/or roughness of the surface and/or terrain such that the ground vehicle may travel at higher speeds with a lower and more aerodynamic profile on smooth terrain and may travel at lower speeds with a higher profile with better clearance on rough terrain. In another embodiment, the one or more swing arm assemblies may use gears (e.g., a sun gear) to facilitate precise rotation of and/or control the angle of rotation of the one or more swing arm assemblies. The one or more swing arm assemblies may include a swing arm, a linear actuator, one or more pushrods, a motor, one or more rockers, one or more lockable pistons, and/or one or more shocks.

Yet another aspect of the present disclosure includes the one or more centerless wheel assemblies that may be coupled with the one or more swing arm assemblies. The one or more centerless wheel assemblies may include the attributes, configurations, features, and embodiments of the centerless wheel assemblies found in U.S. patent application Ser. No. 15/336,540, the entirety of which is hereby incorporated by reference in its entirety. The one or more centerless wheel assemblies may allow the ground vehicle assembly to contact and roll along the ground or other surface. The one or more centerless wheel assemblies may facilitate the directional control of the ground vehicle. Additionally, the one or more centerless wheel assemblies may be independently controlled and/or driven. In some embodiments, the one or more centerless wheel assemblies may include a motor that may cause the one or more centerless wheel assemblies to rotate. In some embodiments, directional control is provided by controlling the rate at which various wheel assemblies are rotated. In addition, the one or more centerless wheel assemblies may be configured such that the one or more centerless wheel assemblies may rotate relative to a plane generally parallel to the one or more platform sides. The rotation of the one or more centerless wheel assemblies may allow the ground vehicle assembly to be turned. The space inside the one or more centerless wheel assemblies may accommodate instruments, devices, and/or components.

In an example embodiment, the space inside the one or more centerless wheel assemblies may be used to accommodate a portion of the one or more swing arm assemblies. In an example embodiment, the space inside the one or more centerless rim assemblies may be used to accommodate brakes, motors, batteries, or any other component. In another example embodiment, the one or more centerless wheel assemblies may include one or more tires, the one or more tires coupled with the one or more centerless rims and configured to roll along the terrain encountered by the ground vehicle. The one or more tires may provide traction and, as a result, may allow the ground vehicle to accelerate, decelerate, and/or turn. The one or more tires may include any shape or profile. The one or more tires may be designed to provide traction for the ground vehicle in a variety of climates and/or conditions including snow, rain, mud, sand, etc.; off-road travel; and high-speed travel. In another example embodiment, the space inside the one or more centerless wheel assemblies may be used to store a battery, generator, and/or other component.

Still yet another aspect of the present disclosure includes one or more centerless wheel assemblies that may include a centerless rim including a first center point laying in a first plane generally defined by the centerless rim. The one or more centerless wheel assemblies may also include a centerless ring gear coupled to or a part of the centerless rim such that rotation of the centerless ring gear causes a corresponding rotation of the centerless rim. The centerless ring gear may include a second center point laying in a second plane generally defined by the centerless ring gear, and the first plane may be generally parallel to the second plane. Additionally or alternatively, the centerless ring gear may be part of the centerless rim such that the second center point and the first center point may be the same point. Additionally, the centerless ring gear may be shaped to interface with a drive gear that drives the centerless ring gear and thus the centerless rim.

Another aspect of the present disclosure includes one or more centerless wheel assembles that may include one or more roller guides shaped and configured to roll along the centerless rim. The centerless rim may include a rail extending towards the first center point. The profile of the one or more roller guides may match a profile of the centerless rim. The one or more centerless wheel assemblies may include one or more exoskeleton plates including a first portion and a second portion, the roller guide supported by one or more roller guide shafts acting as an axle for the one or more roller guides, the one or more roller guide shafts spanning between the first portion and the second portion of the one or more exoskeleton plates.

Still yet another aspect of the present disclosure is a continuous track assembly. In these and other embodiments, one or more centerless wheel assemblies may be coupled together using a continuous track assembly. The continuous track assembly may couple one or more centerless wheel assemblies to one or more additional centerless wheel assemblies such that the rotation of the one or more centerless wheel assemblies causes a corresponding rotation of the one or more additional centerless wheel assemblies.

In an example embodiment, the one or more centerless wheel assemblies may include a continuous track assembly, such as a track and one or more track wheels that may interact with one or more centerless wheels of the ground vehicle, an anchor point on the ground vehicle, or any combinations thereof. In an additional example embodiment, the one or more centerless wheel assemblies may include a half-track system, such as a track and one or more track wheels. In yet another example embodiment, the ground vehicle may operate using a combination of one or more track and/or half-track systems and one or more tires. In yet another example embodiment, the one or more centerless wheel assemblies may include a traction control system. In another example embodiment, the one or more centerless wheel assemblies may be configured to contact the ground such that the ground vehicle may roll along the terrain being traversed by the ground vehicle.

An additional aspect of the present disclosure includes the one or more instruments. The one or more instruments may be present in one or more components of the ground vehicle including the platform, the one or more swing arm assemblies, and/or the one or more centerless wheel assemblies. The one or more instruments may include, for example, computing devices, microchips, mercury switches, accelerometers, transducers, pressure sensors, optical sensors, speedometer, torque sensors, oxygen sensors, cameras, etc. The one or more instruments which may facilitate the use, receipt, and/or transmission of LIDAR, RADAR, laser guidance, GPS systems, WIFI, and/or any other wireless or other radio signals. In an example embodiment, the ground vehicle may be controlled at a distance by communicating with the one or more instruments. In another example embodiment, the ground vehicle may use one or more instruments to detect changes in the terrain and/or climate encountered by the ground vehicle and/or the orientation or speed of the ground vehicle and subsequently adjust the path of the ground vehicle; the height, angle, and/or orientation of the platform; the height, angle, and/or orientation of the one or more swing arm assemblies; and the height, angle, and/or orientation of the one or more centerless wheel assemblies accordingly. In an example embodiment, the ground vehicle may use sensors to detect harmful environmental threats.

Another aspect of the present disclosure includes that the ground vehicle may include one or more components to allow the ground vehicle to communicate with a network. The ground vehicle may be controlled remotely through the network. The ground vehicle may receive information from and/or transmit information to the network. One or more ground vehicles may connect and send and/or receive information via the network. Additionally, the ground vehicle may operate independently of outside communications and operate according to pre-programmed protocols. In addition, the ground vehicle may communicate with one or more other ground vehicles to form a network of ground vehicles. In an example embodiment, the ground vehicle may perform tasks such as measuring environmental factors, surveying terrain, recording sound and video, and/or otherwise performing reconnaissance. In another example embodiment, one or more ground vehicles may communicate to form a system of ground vehicles. The system of one or more ground vehicles may be used to perform one or more tasks.

In an example embodiment, a system of one or more ground vehicles may be transported with the one or more ground vehicles stacked. For example, the one or more ground vehicles may be configured in a substantially planar orientation such that the system of ground vehicles may be stacked upon one another. The one or more ground vehicles may be stacked in order to facilitate shipping and/or deployment. In another example embodiment, the ground vehicles may be maneuvered in such a way that the ground vehicles may be unstacked, one at a time.

Another aspect of the present disclosure may include the ground vehicle being powered by a battery, generator, engine, and/or other power source. Similarly, the components of the ground vehicle, such as the platform, the one or more swing arm assemblies, the one or more centerless wheel assemblies, and the one or more instruments, may be powered by a battery, generator, engine, and/or other power source.

### BRIEF DESCRIPTION OF THE DRAWINGS

Example embodiments will be described and explained with additional specificity and detail through the use of the accompanying drawings in which:

FIG. 1 illustrates a perspective view of an example ground vehicle assembly;

FIG. 2 illustrates a side view of the example ground vehicle assembly of FIG. 1;

FIG. 3 illustrates an alternative side view of the example ground vehicle assembly of FIGS. 1 and 2;

FIG. 4 illustrates a front view of the example ground vehicle assembly of FIGS. 1, 2, and 3;

FIG. 5A illustrates a side view of an example swing arm assembly;

FIG. 5B illustrates a side view of an example swing arm pivot assembly;

FIG. 5C illustrates an additional side view of an example swing arm assembly at various positions;

FIG. 6 illustrates a front view of an example swing arm assembly of an example ground vehicle assembly at various positions;

FIGS. 7-9 illustrate various views of an example system of ground vehicle assemblies;

FIGS. 10A-C illustrate various side views of an example ground vehicle assembly;

FIG. 10D illustrates a top view of the example ground vehicle assembly of FIGS. 10A-C;

FIG. 11A illustrates an exploded view of an example continuous track assembly;

FIGS. 11B-11C illustrate various views of the example continuous track assembly of FIG. 11A;

FIG. 12A illustrates a side view of an example ground vehicle assembly with an example continuous track assembly;

FIG. 12B illustrates a side view of an example ground vehicle assembly with an example continuous track assembly on an example swing arm assembly and an example centerless wheel assembly on another example swing arm assembly;

FIG. 12C illustrates a side view of an example ground vehicle assembly with example continuous track assemblies on example swing arm assemblies;

FIG. 13 illustrates a top cutaway view of an example centerless wheel assembly.

### DESCRIPTION OF EMBODIMENTS

The present disclosure is generally directed to various ground vehicles. Such ground vehicles may include a set of swing arms that are independently moveable in a variety of ways to provide certain flexibilities in operation for the ground vehicle. For example, the ground vehicle may be configured to move each of the swing arms in a rotational manner forward and backward relative to the direction of travel of the ground vehicle. As another example, the ground vehicle may be configured to move each of the swing arm assemblies away from or closer to the ground vehicle in a lateral direction (e.g., perpendicular to the direction of travel of the ground vehicle). By moving each of the swing arms in this manner, the top surface of the ground vehicle may be kept relatively level, regardless of the terrain over which the ground vehicle is traveling and how the swing arms are positioned. Additionally, the ground vehicle may be able to adjust the vertical orientation of the wheel assembly such that even when moving the swing arms in or out, the vertical orientation may be maintained.

The principles of the present disclosure, however, are not limited to ground vehicles. It will be understood that, in light of the present disclosure, the ground vehicle assemblies disclosed herein may have a variety of shapes, sizes, configurations, and arrangements. It will also be understood that ground vehicles assemblies may include any suitable number and combination of features, components, aspects, and the like. It will be further appreciated that the disclosed example embodiments of the ground vehicle assemblies may be used in numerous locations, environments, and arrangements.

Example embodiments of the ground vehicle assemblies are disclosed and described in detail below. It will be understood that different embodiments may have one or more different parts, components, features and aspects; and the different parts, components, features and aspects may not be required. Further, it will be understood that different embodiments may include various combinations of these parts, components, features and aspects depending, for example, upon the intended use of the ground vehicle assembly.

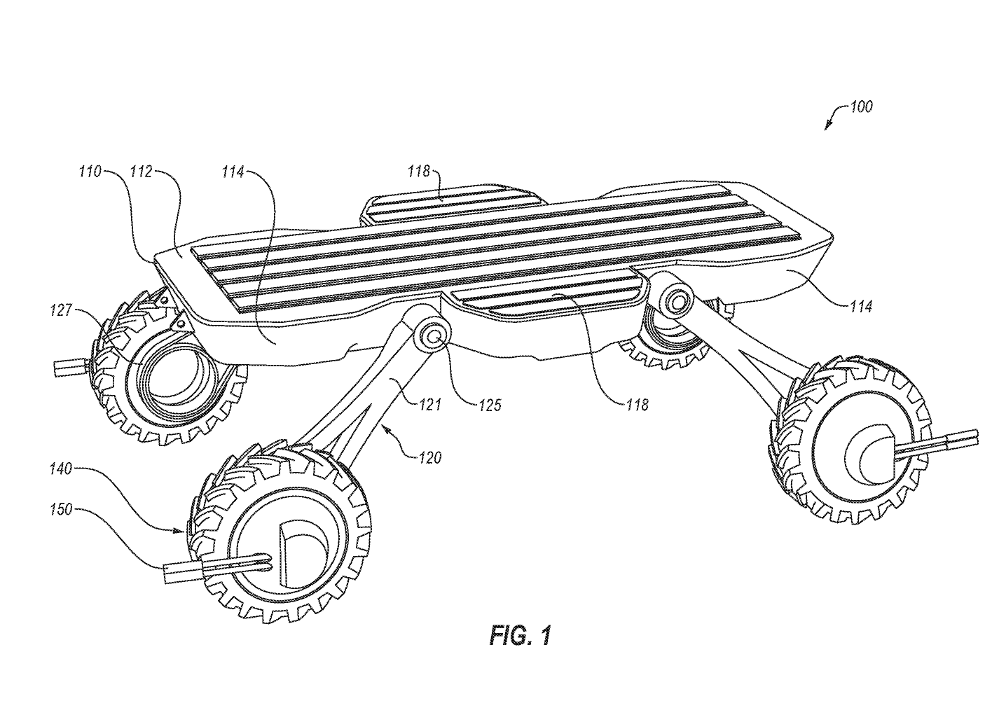

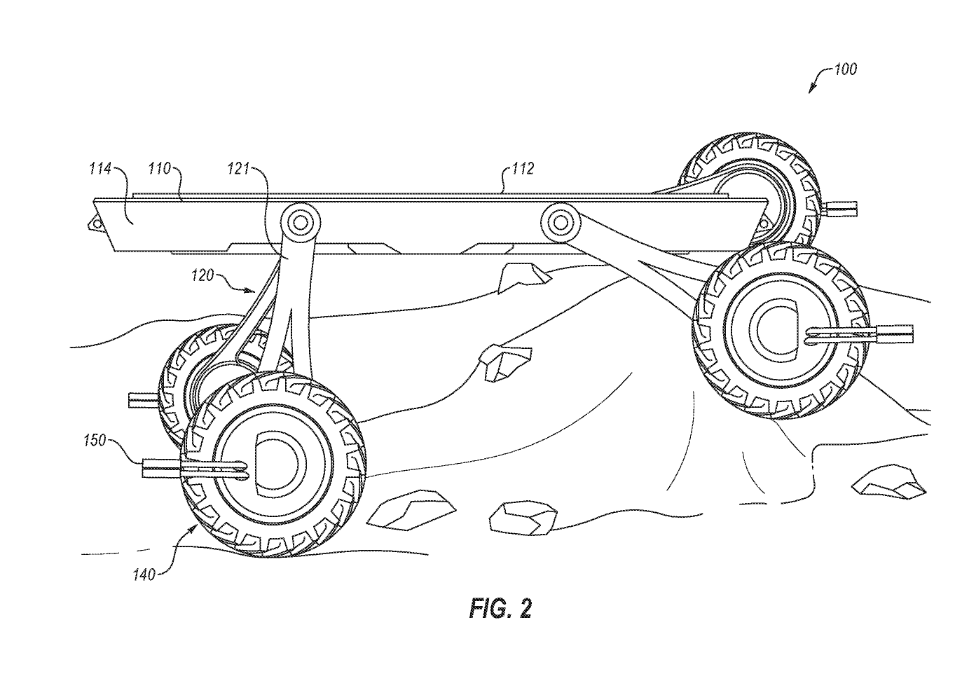

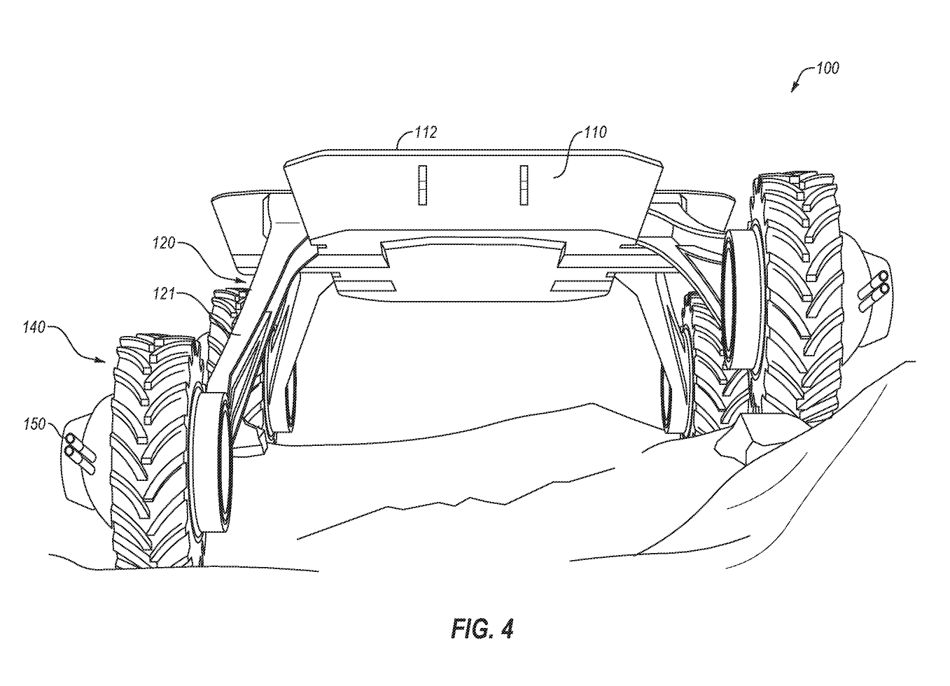

FIGS. 1-4 illustrate various views of an example ground vehicle assembly 100. As illustrated in FIGS. 1-4, the ground vehicle assembly 100 may include a platform 110, swing arm assemblies 120, centerless wheel assemblies 140, and one or more instruments 150. Various examples of a centerless wheel and uses thereof are described in U.S. application Ser. No. 15/336,540 (now U.S. Pat. No. 9,764,592), the entire disclosure of which, whether regarding centerless wheel assemblies or otherwise, is incorporated by reference herein in its entirety. The platform 110 may interface with the swing arm assemblies 120. A proximal end 125 of the swing arm assemblies 120 may be coupled to the platform sides 114 of the platform 110 in such a way that the swing arm assemblies 120 may rotate along a plane generally parallel to the platform side 114 of the platform 110 to which the swing arm assembly 120 is coupled. The centerless wheel assemblies 140 may be coupled to a distal end 127 of the swing arm assemblies 120. The instruments 150 may be coupled to the centerless wheel assemblies 140.

The platform 110 may include a device or component that may act as a base, chassis, frame, and/or structure of the ground vehicle assembly 100. As illustrated in FIGS. 1-4, the platform 110 may include a generally rectangular shape with the top surface 112 being substantially flat. The platform 110 may include platform sides 114, where the platform sides 114 may be generally perpendicular to a plane generally defined by the top surface 112. The platform 110 may also include one or more platform extensions 118 which may be located between the swing arm assemblies 120. The platform extensions 118 may also include a generally rectangular shape.

The platform 110 may include any shape or profile. The platform 110 may include a profile that is substantially smooth. For example, the length and width of the top surface 112 may fall within the approximate range of 0.5 feet to 12 feet by 0.5 feet to 12 feet. In addition, the height of the one or more platform sides may fall within the approximate range of 1 inch to 4 feet. For example, the platform may be sized similar to the chassis used in golf carts, all-terrain vehicles, mobility devices, lawn and garden machines, planetary rovers, automobiles, and/or other vehicles.

The swing arm assemblies 120 may include a device or component that may act to raise, lower, and/or stabilize the platform 110 relative to a terrain or a surface located below the ground vehicle assembly 100. The swing arm assemblies 120 may also act to dampen vibrations experienced by the various components of the ground vehicle assembly 100 as the ground vehicle assembly 100 traverses various terrains or surfaces. As illustrated in FIGS. 1-4, the swing arm assemblies 120 may include a swing arm 121, a proximal end 125, and a distal end 127. In some embodiments, the swing arm assemblies 120 may be coupled to a respective platform side 114 in sets, such as a pair of the swing arm assemblies 120 may be coupled to one platform side 114 while another pair of the swing arm assemblies 120 may be coupled to an opposite platform side 114. The sets may include more than two swing arm assemblies 120.

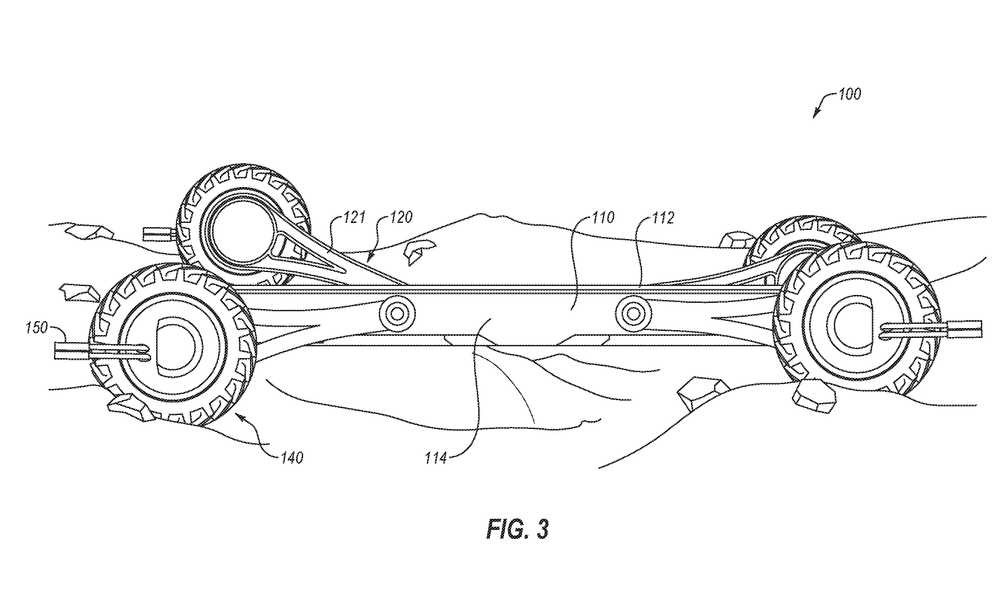

The swing arm assemblies 120 may include any shape or profile. The proximal end 125 of the swing arm assemblies 120 may be rotatably coupled with a respective platform side 114. The proximal end 125 may include a circular shape or any other shape or profile. The distal end 127 of the swing arm assemblies 120 may be coupled with the centerless wheel assemblies 140. As illustrated in FIGS. 1-4, the proximal end 125 may act as a pivot point such that the proximal end 125 of the swing arm assemblies may remain rotatably coupled to the respective platform side 114 while the swing arm 121 and the distal end 127 may rotate in a generally circular path around the proximal end 125. In some embodiments, the swing arm assembly 120 may rotate until the swing arm 121 is substantially parallel to the top surface 112, effectively lowering the platform 110 to the ground or surface. In some embodiments, the swing arm assemblies 120 may rotate until the swing arm 121 is substantially perpendicular to the top surface 112 effectively raising the platform 110 to at least a height equivalent to the length of the swing arm assemblies 120. In some embodiments, the swing arm assemblies 120 may be configured to rotate beyond a vertical or a horizontal position relative to the top surface 112. For example, as illustrated in FIG. 3, one of the swing arm assemblies 120 is rotated such that the distal end of the swing arm 121 is above the top surface 112 of the platform 110.

The centerless wheel assemblies 140 may allow the ground vehicle assembly 100 to contact and roll along the ground or other surface and may facilitate the directional control of the ground vehicle assembly 100. In some embodiments, the centerless wheel assemblies 140 may include a device or component that may translate the input provided by the swing arm assemblies 120 and/or a power source into directional motion. The centerless wheel assemblies 140 may include a motor or other component that may drive the centerless wheel assemblies 140. For example, each of the centerless wheel assemblies 140 may include a motor or other component that may drive the respective centerless wheel assembly 140 such that the ground vehicle assembly 100 may move along the ground or other surface. The centerless wheel assemblies 140 may be rotatably coupled to the swing arm assemblies 120. The centerless wheel assemblies 140 may also be rotatably coupled to tires.

The instruments 150 may include any of a variety of feature sets that may be added to the ground vehicle assembly 100. For example, the instruments 150 may be present in one or more components of the ground vehicle assembly 100 including the platform 110, the swing arm assemblies 120, and the centerless wheel assemblies 140. The instruments 150 may include for example, computing devices, microchips, mercury switches, accelerometers, transducers, pressure sensors, optical sensors, speedometer, torque sensors, oxygen sensors, cameras, etc. The one or more instruments 150 which may facilitate the use, receipt, and transmission of LIDAR, RADAR, laser guidance, GPS systems, WIFI, and/or any other wireless or other radio signals. In another example embodiment, the ground vehicle assembly 100 may use the instruments 150 to detect changes in the terrain and climate encountered by the ground vehicle and/or the orientation or speed of the ground vehicle assembly 100 and subsequently adjust the path of the ground vehicle assembly 100; the height, angle, and/or orientation of the platform; the height, angle, and/or orientation of the one or more swing arm assemblies 120; and/or the height, angle, and/or orientation of the centerless wheel assemblies 140 accordingly. In an example embodiment, the ground vehicle assembly 100 may use sensors to detect harmful environmental threats.

In some embodiments, the ground vehicle 100 may be steered by varying the speeds at which the individual centerless wheels 140 are rotated. For example, if the centerless wheels 140 on one side are rotated more quickly and the centerless wheels 140 on the other side are slowed or even reversed, the ground vehicle 100 may turn in the direction of the slowed and/or reversed centerless wheels 140. Additionally or alternatively, the ground vehicle 100 may be steered using push rods or other more traditional steering mechanisms coupled to the centerless wheel assemblies 140. Additionally or alternatively, the ground vehicle 100 may be steered using a gear and/or motor component that couples the swing arm assembly 120 to the centerless wheel assembly 140 in a manner that permits the gear and/or motor to rotate the centerless wheel assembly relative to the direction the ground vehicle 100 is traveling.

Modifications, additions, or omissions may be made to the ground vehicle assembly 100 of FIGS. 1-4. For example, the ground vehicle assembly 100 may include more or fewer elements than those illustrated in FIGS. 1-4. As an example, the ground vehicle assembly 100 may include an instrument 150 fixedly coupled to the top of the platform 110, such as a crane, artillery, etc. As another example, the ground vehicle assembly 100 may include more or fewer swing arm assemblies 120 on one or both sides of the ground vehicle assembly 100.

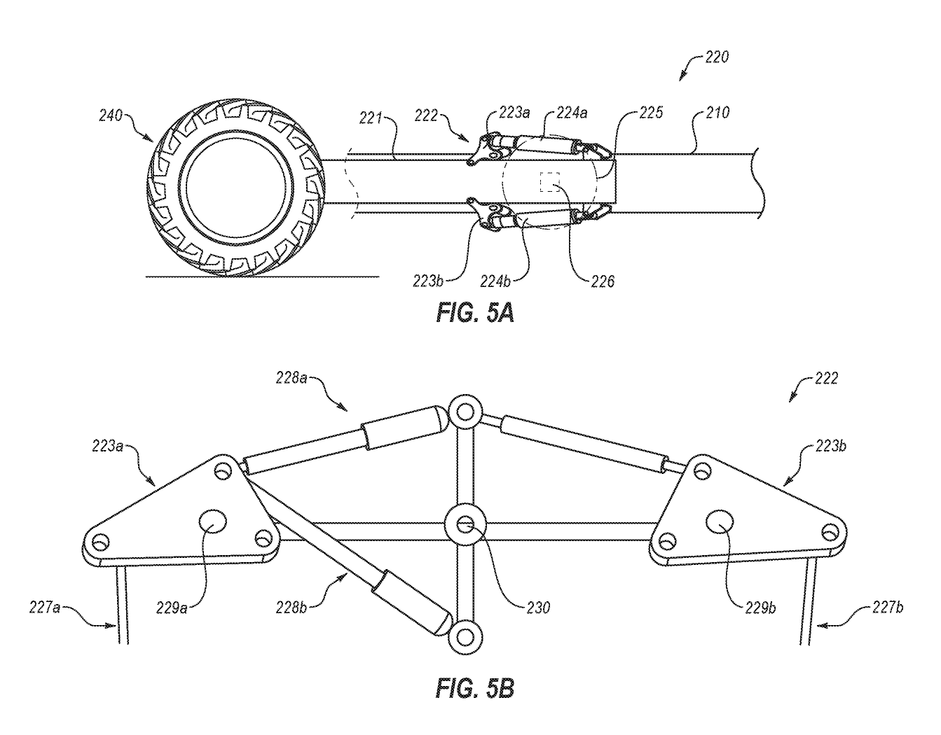

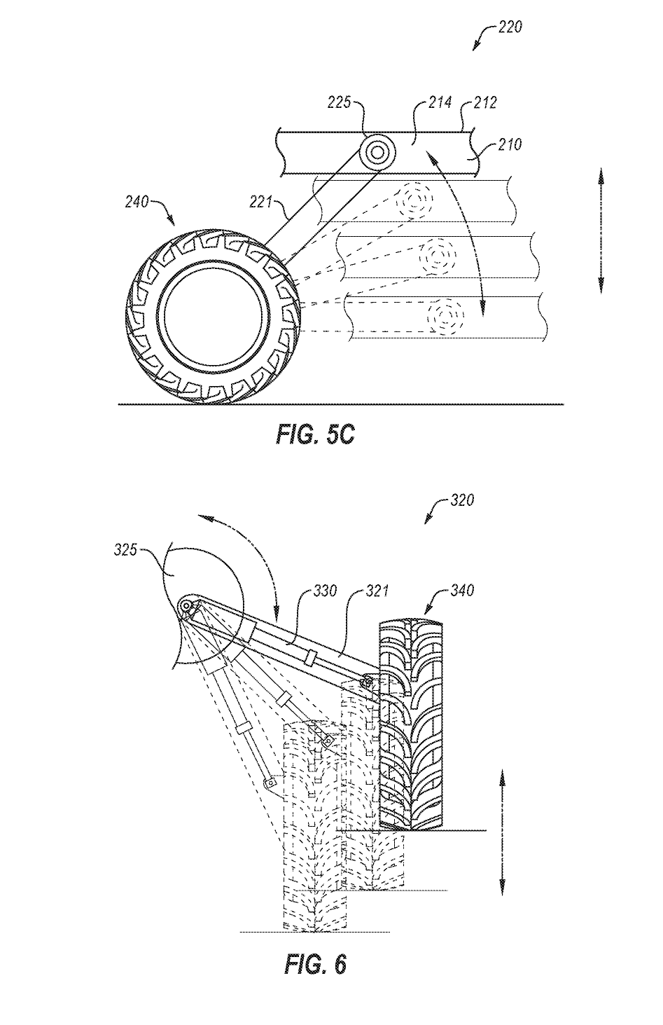

FIG. 5A illustrates a side view of an example swing arm assembly 220 of an example ground vehicle assembly. As illustrated in FIG. 5A, the swing arm assembly 220 may include a swing arm 221, a swing arm pivot assembly 222, one or more rockers 223 (e.g., the rockers 223a and 223b), one or more shock absorbers 224 (e.g., the shock absorbers 224a and 224b), a pivot 225, and a stepper motor 226. The swing arm assembly 221 may be coupled to the platform 210. A proximal end of the swing arm 221 may be rotatably coupled with the platform 210 via the pivot 225. A distal end of the swing arm 221 may be coupled with a centerless wheel assembly 240. In some embodiments, the swing arm assembly 220 may be configured to absorb forces encountered by the swing arm assembly 220. For example, in some embodiments, the shock absorbers 224 may absorb and/or dampen forces that may be transferred to the swing arm assembly 220 via the centerless wheel assemblies 240. In some embodiments, the shock absorbers 224 may absorb vibrations encountered by the swing arm assembly 220 and allow the platform 240 to remain substantially level. The pivot 225 may allow the swing arm 221 to rotate about the pivot 225 while maintaining a path substantially parallel with the platform side of platform 210 to which the swing arm 221 is coupled. In some embodiments, the stepper motor 226 may be used to facilitate the rotation of the swing arm 221 around the pivot 225.

FIG. 5B illustrates an example swing arm pivot assembly 222 of an example ground vehicle assembly. As illustrated in FIG. 5B, the swing arm pivot assembly 222 may include one or more rockers 223 (e.g., the rockers 223a and 223b), one or more pushrods 227 (e.g., the pushrods 227a and 227b), one or more lockable pistons 228 (e.g., the lockable pistons 228a and 228b), one or more pivot points 229 (e.g., the pivot points 229a and 229b), and frame 230. As illustrated in FIG. 5A, the swing arm pivot assembly 222 may be coupled to swing arm assembly 220. The swing arm pivot assembly 222 may also control the movement of swing arm assembly 220 (see FIG. 5A). In an example embodiment, the swing arm pivot assembly 222 may be coupled to a stepper motor 226 (see FIG. 5A) to facilitate the rotation of the swing arm pivot assembly 222. The frame 230 of the swing arm assembly 223 may be coupled to a center point of the pivot 225 (see FIG. 5A). A proximal end of the one or more pushrods 227 may be coupled to a proximal end of the swing arm 221 and may extend adjacent to and substantially parallel to an axis running through a length of the swing arm 221 (see FIG. 5A). A distal end of the one or more pushrods 227 may be coupled to the one or more rockers 223. The one or more rockers 223 may be coupled to the frame 230 at one or more pivot points 229 and may also be coupled to one or more shock absorbers 224. In an example embodiment, the shock absorbers 224 may absorb vibrations as the swing arm 221 pivots and/or rotates substantially parallel to the plane generally defined by the platform side of the vehicle ground assembly to which the swing arm assembly 220 is coupled (not shown in FIG. 5B).

Modifications, additions, or omissions may be made to the swing arm assembly 220 and/or the swing arm pivot assembly 222 of FIGS. 5A and 5B, respectively. For example, the swing arm assembly 220 and/or the swing arm pivot assembly 222 may include more or fewer elements than those illustrated in FIGS. 5A and 5B.

FIG. 5C illustrates an additional side view of an example swing arm assembly 220 of an example ground vehicle assembly at various positions. As illustrated in FIG. 5C, the swing arm 221 may be rotatably coupled with a respective platform side 214 of platform 210. The swing arm 221 may be substantially parallel to the plane generally defined by the platform side 214 to which the swing arm assembly 220 is coupled. In some embodiments, the swing arm assembly 220 may be rotatably coupled to the platform 210, with pivot 225 acting as a pivot point and permitting rotation of the swing arm assembly 220 along a circular path substantially parallel to the plane generally defined by the platform side 214 and around pivot 225. In some embodiments, the swing arm 221 may rotate between the angles of about zero degrees and about three hundred and sixty degrees, between about negative thirty degrees and two hundred and ten degrees, and/or between about zero degrees and one hundred and eighty degrees, as measured from a plane substantially parallel to the top surface 212. In some embodiments, a change in the angle between the swing arm 221 and the top surface 212 leads to an increase or decrease in the distance between the platform 210 and the ground or other surface.

Modifications, additions, or omissions may be made to the swing arm assembly 220 and/or the swing arm pivot assembly 222 of FIGS. 5A-5C. For example, the swing arm assembly 220 and/or the swing arm pivot assembly 222 may include more or fewer elements than those illustrated in FIGS. 5A-5C.

FIG. 6 illustrates a front view of an example swing arm assembly 320 of an example ground vehicle assembly at various positions. As illustrated in FIG. 6, the swing arm assembly 320 may include a swing arm 321, a pivot 325, one or more linear actuators 330, and one or more centerless wheel assemblies 340. The swing arm 321 may be rotatably coupled with pivot 325 and may extend in a direction generally perpendicular and/or away from the side of a platform. The swing arm 321 may also be rotatably coupled to the centerless wheel assembly 340. In addition, the swing arm 321 may be coupled to the linear actuators 330. The linear actuators 330 may be extended or retracted in length and may be coupled to the pivot 325 and may also extend in a direction generally away from the platform and/or the swing arm 321. In some embodiments, the linear actuators 330 may be extended in length such that the angle between a plane generally defined by the top surface of the platform (not illustrated) and the swing arm 321 is increased, effectively decreasing the wheelbase of the ground vehicle created by one or more pairs of the centerless wheel assemblies 340.

In some embodiments, the linear actuators 330 may be retracted in length such that the angle between the plane generally defined by the top surface of the platform (not illustrated) and the swing arm 321 is decreased, effectively increasing the wheelbase of the ground vehicle created by one or more pairs of the centerless wheel assemblies 340. The centerless wheel assemblies 340 may have a positive, neutral, or negative camber angle with respect to the plane generally defined by the top surface of the platform (not illustrated) and/or the ground or other surface. In some embodiments, the extension of the linear actuators 330 may not alter the camber angle of the centerless wheel assemblies 340. For example, the extension of the linear actuators 330 may not affect the camber angle such that the camber angle may remain the same throughout the extension of the linear actuators 330. In some embodiments, the extension of the linear actuators 330 may alter the camber angle of the centerless wheel assemblies 340. For example, the extension of the linear actuators 330 may increase the camber angle such that the camber angle becomes more positive, such as to approximate a zero camber angle at maximum extension of the linear actuators 330. In some embodiments, the extension of the linear actuators 330 may decrease the camber angle such that the camber angle becomes more negative.

In some embodiments, the swing arm assembly 320 may include a component coupling the swing arm 321 to the centerless wheel assembly 340 that may adjust the orientation of coupling and lock the orientation. For example, a gear with a driving motor may form part of the coupling between the swing arm assembly 320 and the centerless wheel assembly 340 such that by driving the motor, the gear may be moved to cause the camber of the centerless wheel assembly 340 to be changed. In some embodiments, at least a portion of such a component (e.g., the motor and/or the driving gear) may be disposed within the void in the middle of the centerless wheel assembly 340.

In some embodiments, the component coupling the swing arm 321 to the centerless wheel assembly 340 may adjust the horizontal orientation in addition to or instead of the vertical orientation. For example, such a component may vary the orientation of the centerless wheel assembly 340 relative to the swing arm 321 such that the ground vehicle turns because the centerless wheel assembly 340 has turned relative to the direction in which the ground vehicle is traveling. In some embodiments, such a component may include a motor and/or driving gear. IN some embodiments, a separate motor and/or driving gear may be used for vertical orientation (e.g., camber) of the wheel vs. horizontal orientation (e.g., direction of turning to move the ground vehicle).

Modifications, additions, or omissions may be made to the swing arm assembly 320 of FIG. 6. For example, the swing arm assembly 320 may include more or fewer elements than those illustrated in FIG. 6. For example, the swing arm assembly 320 may include a motor and/or other element to modify and/or lock the camber of the centerless wheel assembly 340.

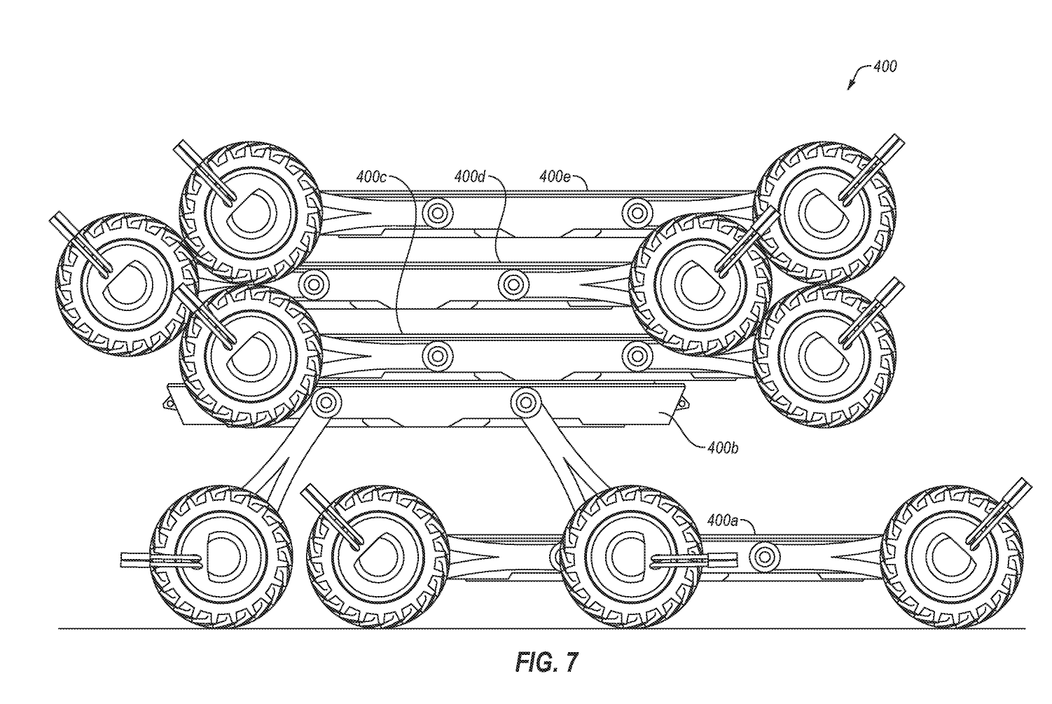

FIGS. 7-9 illustrate various views of an example system of ground vehicles assemblies 400, including ground vehicle assemblies 401a-401e. As illustrated in FIG. 7, the components of each of the ground vehicle assemblies 401a-401e may be configured in a substantially planar orientation such that the system of ground vehicle assemblies 400 may be stacked upon one another. In some embodiments, the ground vehicle assemblies 401a-e may be stacked in order to facilitate shipping and/or deployment. In some embodiments, the ground vehicle assemblies 401a-401e may be maneuvered in such a way that the ground vehicle assemblies 401a-e may be unstacked, one at a time. In some embodiments, a ground vehicle such as ground vehicle assembly 401a may be located at the bottom of a stack of ground vehicle assemblies 401a-401e. In some embodiments, the ground vehicle assembly 401b may be located in a position second from the bottom of the stack and be maneuvered in such a way to carry ground vehicle assembles 401c-401e away from being positioned on top of ground vehicle assembly 401a, allowing ground vehicle assembly 401a to be removed from the stack of ground vehicles assemblies 400, including ground vehicle assemblies 401a-401e.

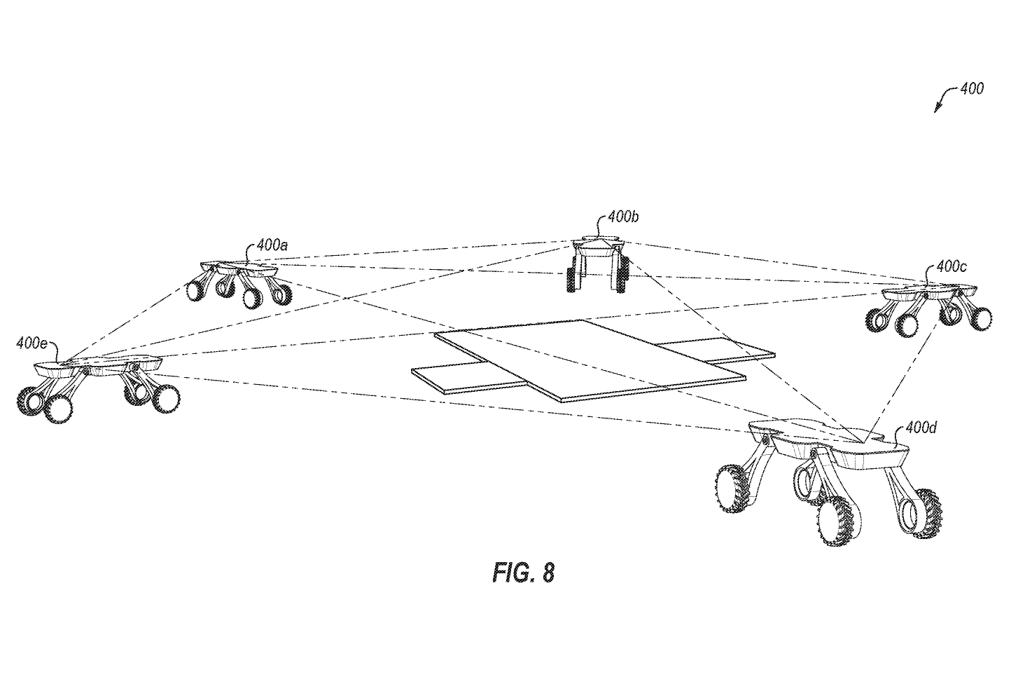

As illustrated in FIG. 8, the system of ground vehicle assemblies 401a-401e may be communicatively coupled. For example, the system of ground vehicle assemblies 401a-401e may join and/or form a communication network in order to communicate with each of the ground vehicle assemblies 401a-401e.

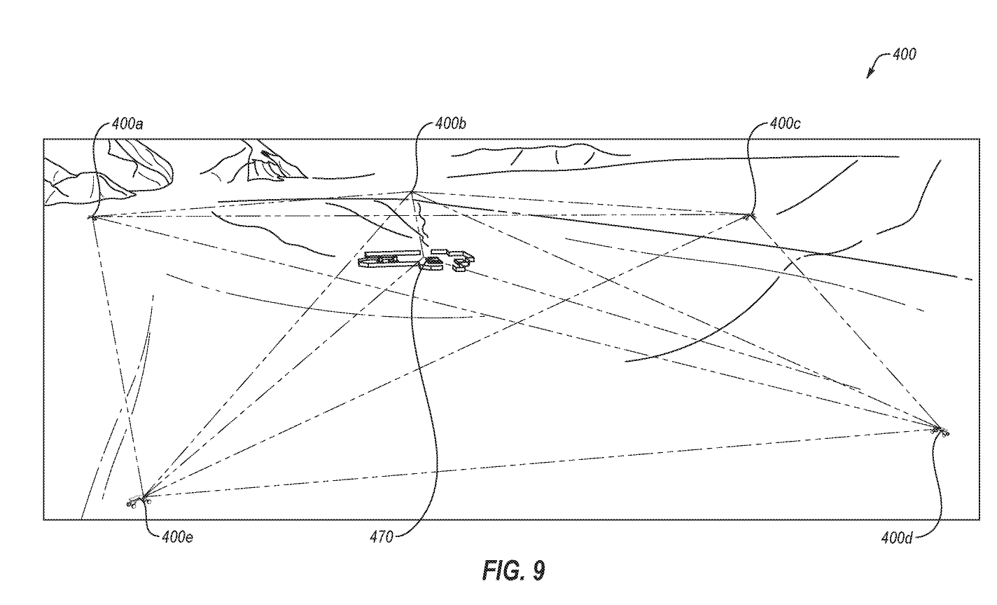

As illustrated in FIG. 9, the system of ground vehicle assemblies 400a-400e may form and/or travel in various formations. In some embodiments, the system of ground vehicle assemblies 400a-400e may perform tasks such as measuring environmental factors, surveying terrain, recording sound and video, and/or otherwise performing reconnaissance. In some embodiments, the system of ground vehicle assemblies 400a-400e may form a perimeter around a designated area 470.

Modifications, additions, or omissions may be made to the system of ground vehicles assemblies 400a-400e of FIGS. 7-9. For example, the system of ground vehicle assemblies 400a-400e may include more or fewer elements than those illustrated in FIGS. 7-9. For example, any number of ground vehicle assemblies may be included in the system. Additionally or alternatively, the ground vehicles may include any number of tools or instruments to facilitate communication and/or analysis of certain regions.

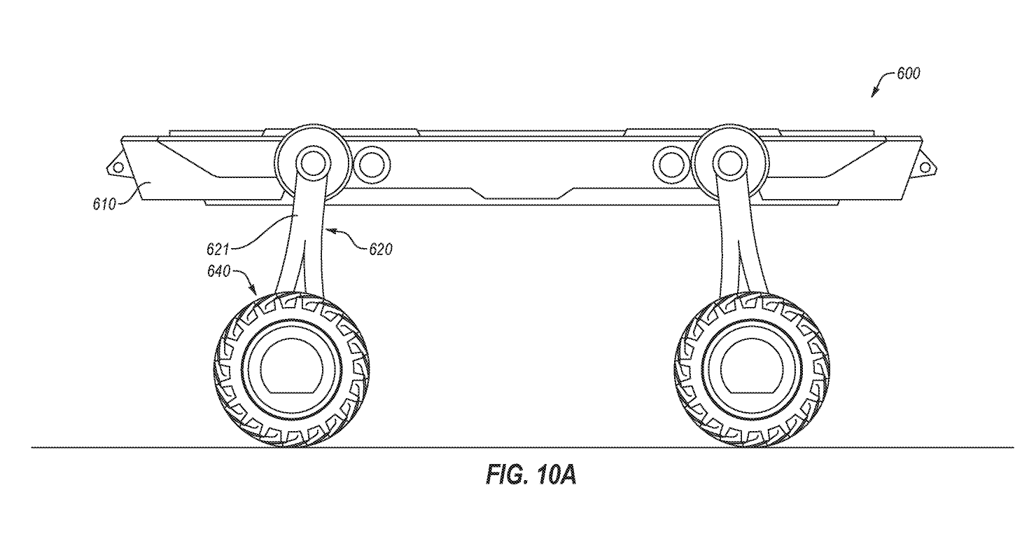

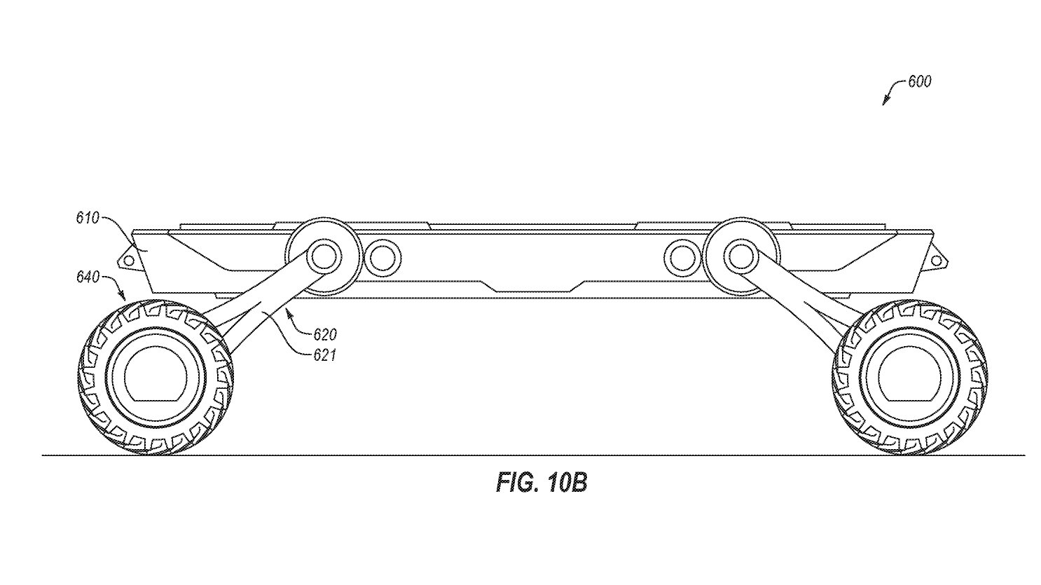

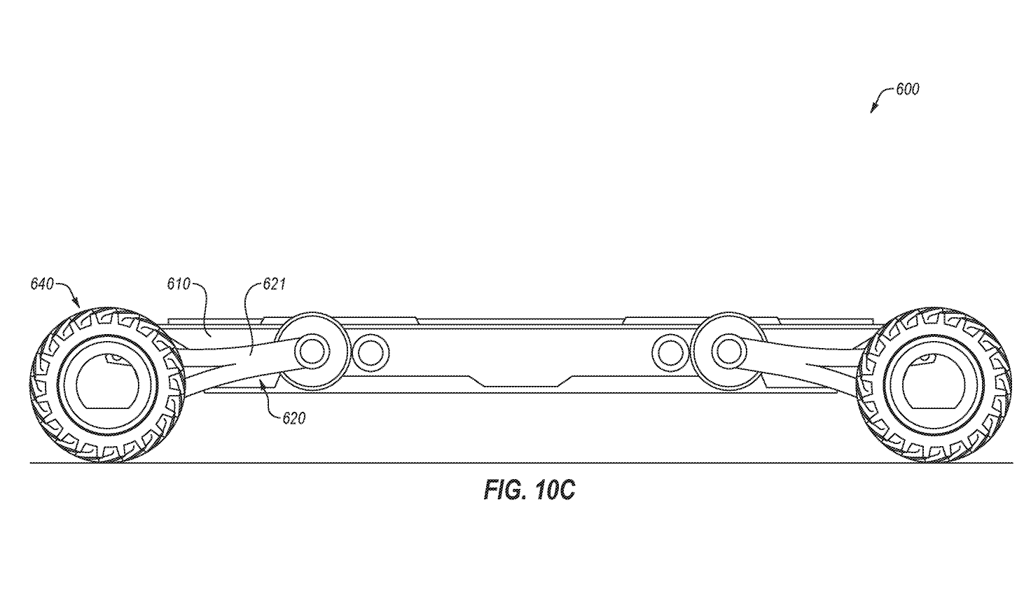

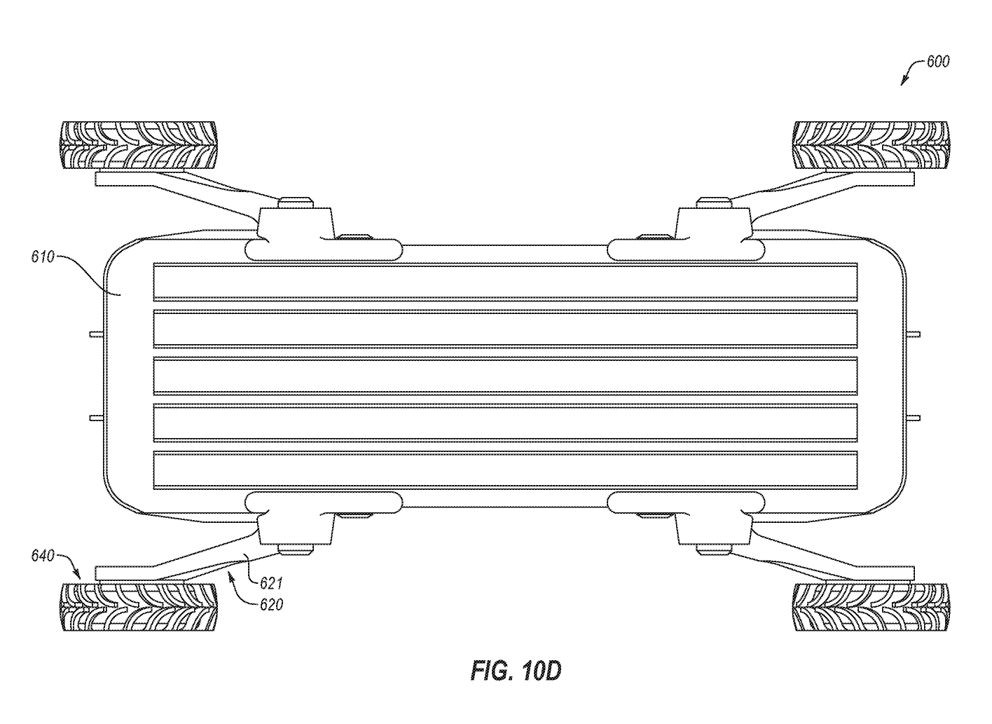

FIGS. 10A-10D illustrate various views of an example ground vehicle assembly 600. As illustrated in FIGS. 10A-10D, the ground vehicle assembly 600 may include a platform 610, one or more swing arm assemblies 620, and one or more centerless wheel assemblies 640. FIG. 10A illustrates a view of the ground vehicle assembly 600 with the swing arms assemblies 620 nearly vertical. FIG. 10B illustrates a view of the ground vehicle assembly 600 with the swing arm assemblies 620 transitioning towards horizontal or level. FIG. 10C illustrates a view of the ground vehicle assembly 600 with the swing arm assemblies 620 approximately horizontal or level. FIG. 10D illustrates a top down view of the ground vehicle assembly 600. The platform 610 may interface with the one or more swing arm assemblies 620. The one or more swing arm assemblies 620 may be coupled to the platform 610 in such a way that the swing arm assemblies 620 may rotate. The one or more swing arm assemblies 620 may be rotatably coupled to the one or more centerless wheel assemblies 640 such that the ground vehicle assembly 600 is able to move along the ground or other surface with the rotation of the one or more centerless wheel assemblies 640.

Modifications, additions, or omissions may be made to the ground vehicle assembly 600 of FIGS. 10A-10D. For example, the ground vehicle assembly 600 may include more or fewer elements than those illustrated in FIGS. 10A-10D. Additionally or alternatively, the ground vehicle assembly 600 may include any of the modifications or variations described in the present disclosure.

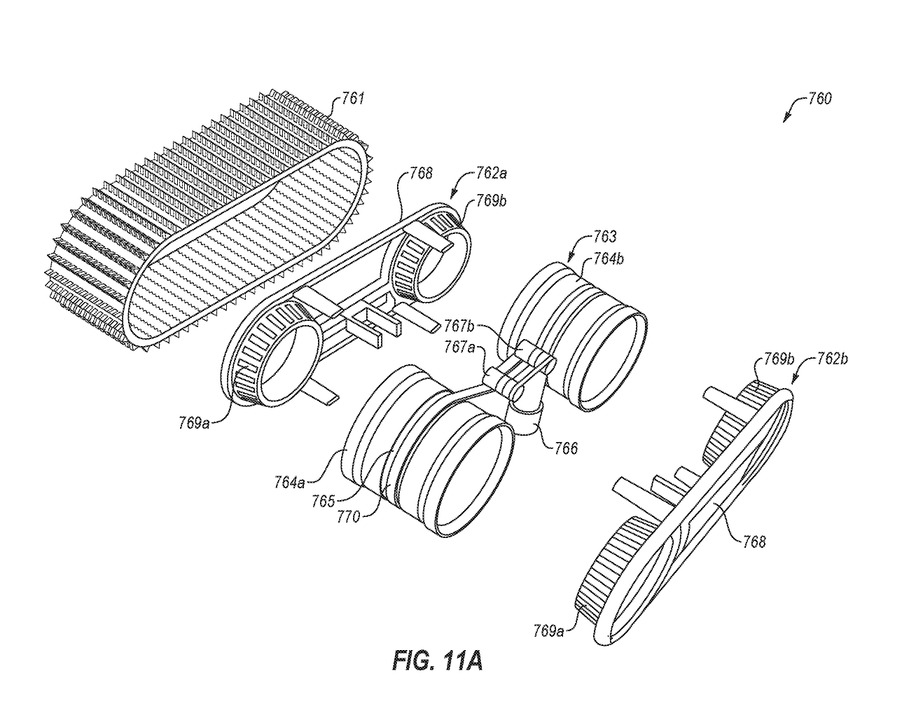

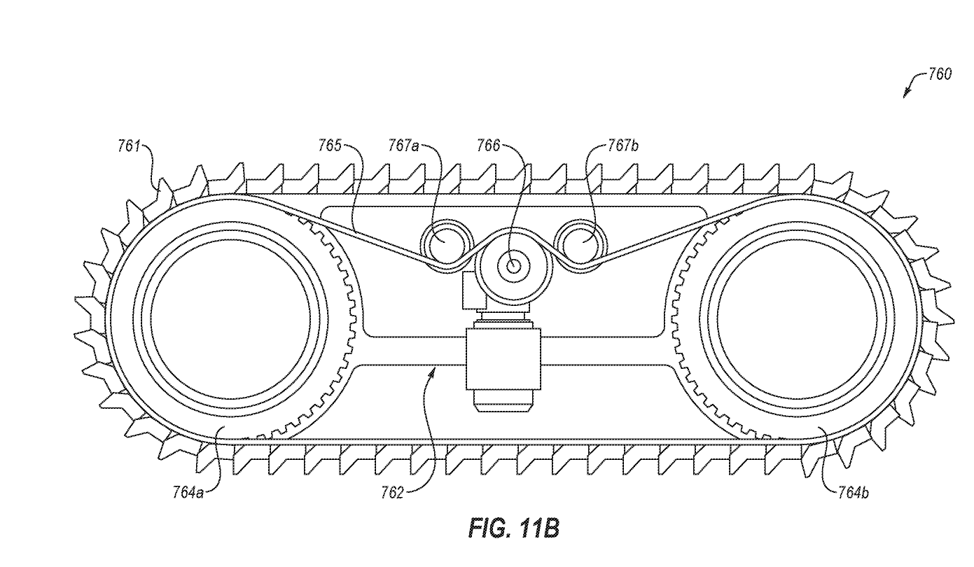

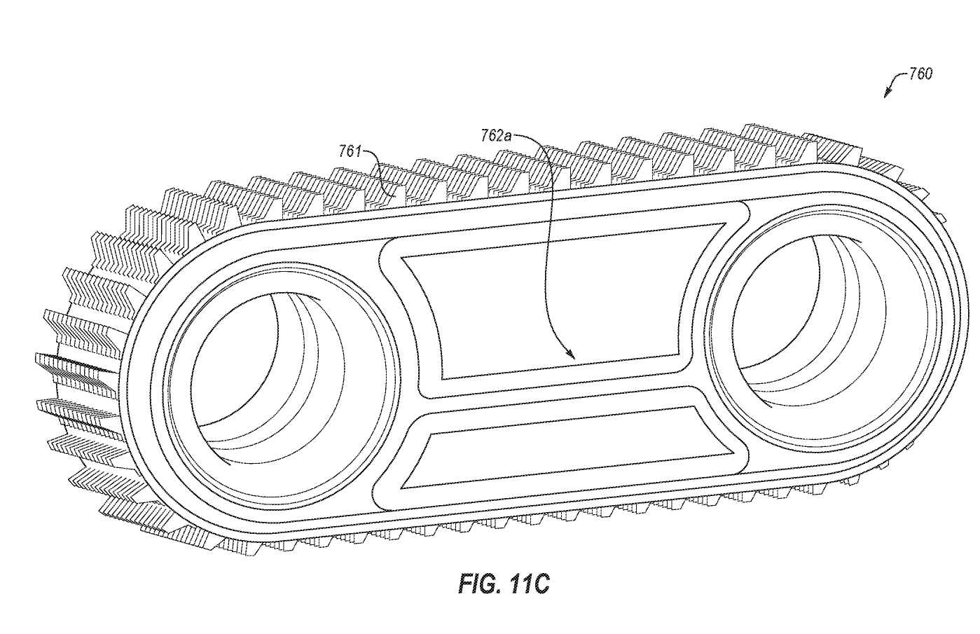

FIGS. 11A-11C illustrate various views of an example embodiment of a continuous track assembly 760. FIG. 11A includes an exploded view of the continuous track assembly 760. FIG. 11B includes a side view of the continuous track assembly 760. FIG. 11C includes a perspective view of the continuous track assembly 760. As illustrated in FIGS. 11A-11C, the continuous track assembly 760 may include a continuous track 761, one or more exoskeleton plates 762 (e.g., 762a and 762b), and a dual centerless rim assembly 763. The exoskeleton plates 762 may interface with one or more swing arm assemblies (not illustrated). In these and other embodiments, the dual centerless rim assembly 763 may be indirectly coupled with the one or more exoskeleton plates 762 via rollers or some other element permitting rotation of the centerless rims relative to the exoskeleton plates 762. The continuous track 761 may be rotatably coupled with the dual centerless rim assembly 763 such that rotation of the dual centerless rim assembly 763 may cause a corresponding rotation of the continuous track 761.

The one or more continuous track assemblies 760 may allow the ground vehicle 700 to contact and roll along the terrain encountered by the ground vehicle (not illustrated) and may facilitate the directional control of the ground vehicle 700. In some embodiments, the one or more continuous track assemblies 760 may include a device or component that may translate the input provided by the one or more swing arm assemblies (not illustrated) and/or a power source into directional motion. The one or more continuous track assemblies 760 may be rotatably coupled to the one or more swing arm assemblies (not illustrated). In some embodiments, the one or more continuous track assemblies 760 may be coupled with the one or more swing arm assemblies in such a way that the front face 768 of the one or more exoskeleton plates 762 is substantially parallel to the plane generally defined by platform side to which the swing arm is coupled.

The continuous track 761 may include a device or component that may contact the ground, creating a large surface area for contact of the ground in order to distribute the weight of the ground vehicle assembly, and provide traction to the dual centerless rim assembly 763 and the ground vehicle assembly. The continuous track 761 may include multiple stationary components mechanically coupled to allow some motion between the stationary components. In some embodiments, the continuous track 761 may operate in a similar manner to a tank track. As illustrated in FIGS. 11A-11C, the continuous track 761 may include a profile that is generally elliptical in shape when positioned around the dual centerless rim assembly 763. In some embodiments, the continuous track 761 may include any profile or shape, for example, to accommodate various architectures of components imparting the motive force to the continuous track 761. As illustrated in at least FIGS. 11A-11C, the width of the continuous track 761 may be such as to accommodate the width of the dual centerless rim assembly 763.

In some embodiments, the continuous track 761 may be a continuous piece of material. In some embodiments, the continuous track 761 may be made up of many different pieces of material. In addition, the continuous track 761 may consist of a series of links, modular plates, and/or a combination thereof and may be reinforced with wires and/or rods. The continuous track 761 may be constructed of any material, such as metal, rubber, composite materials, etc. In some embodiments, the continuous track 761 may be a “dead” track, with one or more track plates connected to each other with one or more hinge pins. In some embodiments, the continuous track 761 may be a “live” track. In some embodiments, the continuous track 761 may contain a tread pattern on the outer portion that may increase the traction of the continuous track 761 on the various terrain that is encountered by the continuous track assembly 760. In some embodiments, the continuous track 761 may contain a tread pattern on the inner portion that may decrease the likelihood of slippage between the continuous track 761 and the dual centerless rim assembly 763.

The one or more exoskeleton plates 762 may include a device or component that may remain stationary relative to the motion of the dual centerless rim assembly 763 and/or the ground vehicle assembly (not illustrated). In some embodiments, the one or more exoskeleton plates 762 may include the attributes, configurations, features, and embodiments of the exoskeleton plates described in U.S. application Ser. No. 15/336,540. As illustrated in FIGS. 11A-11C, the one or more exoskeleton plates 762 (e.g., 762a) may be coupled to one or more other exoskeleton plates 762 (e.g., 762b). The one or more inner rims 769 (e.g., 769a and 769b) of the one or more exoskeleton plates 762 may share a central axis of rotation with and interface with an inside portion of the one or more centerless rims 764 (e.g., 764a and 764b) in such a way that allows the one or more centerless rims 764 to rotate in a general manner around the diameter of the one or more inner rims 769 of the one or more exoskeleton plates 762. For example, roller, bearings, etc. may be disposed between the exoskeleton plates 762 and the dual centerless rim assembly 763.

The dual centerless rim assembly 763 may include a device or component that may be used to drive the continuous track 761. As illustrated in FIGS. 11A-11C, the dual centerless rim assembly 763 may include one or more centerless rims 764, a motor 766, one or more rollers 767 (e.g., 767a and 767b), and a belt 770.

The one or more centerless rims 764 may interface with the belt 770 such that a rotation and/or translation of the belt 770 enacts a corresponding rotation of the one or more centerless rims 764. In some embodiments, the one or more centerless rims 764 may include the attributes, configurations, features, and embodiments of the centerless rims described in U.S. application Ser. No. 15/336,540. As illustrated in FIG. 11A-11C, the one or more centerless rims 764 may rotate about an axis that is generally perpendicular to the side of the platform of a ground vehicle to which a swing arm assembly supporting the continuous track assembly 760 is coupled.

The one or more centerless rims 764 may be generally cylindrical in shape and include a generally circular profile. In some embodiments, the one or more centerless rims 764 may have a thin-walled cylindrical shape. The one or more centerless rims 764 may be constructed of any material, such as metal, rubber, plastic, composite materials, etc. In some embodiments, the one or more centerless rims 764 may contain a groove 765 within which the one or more centerless rims 764 may interface with the belt 770. In some embodiments, the interface between the one or more centerless rims 764 and the belt 770 may include gears or gear teeth, roller guides, etc. In some embodiments, the one or more centerless rims 764 may be friction driven or geared-tooth driven through an interaction with the belt 770.

In some embodiments, the one or more centerless rims 764 may have a positive, neutral, or negative camber angle with respect to the plane generally defined by a top surface of the platform of the ground vehicle (not illustrated) and/or the ground or other surface. In some embodiments, one or more exoskeleton plates 769 may be coupled with the swing arm in such a way that allows the camber angle of the one or more centerless rims 764, the dual rim centerless rim assembly 763, and/or the entire continuous track assembly 760 to be changed.

The motor 766 may include any source of motive power. For example, the motor 766 may include an electric motor, fuel-powered motor, a human-powered motive device, or other device that provides motive force. As illustrated in FIGS. 11A-11C, the motor may be coupled with the belt 770 in such a way that as the motor 766 rotates, the motor 766 enacts a corresponding translation and/or rotation of the belt 770. In some embodiments, the use of a small motor may be available because of the gearing ratio from the one or more rollers 767 to the belt 770.

The belt 770 may be configured to interface with the one or more rollers 767 such that the rotational motion of the one or more rollers 767 may cause the belt 770 to undergo rotational and/or translational motion. The belt 770 may also be configured to transfer the rotational motion of the one or more rollers 767 to the one or more centerless rims 774 such that as the one or more rollers 767 rotates, the belt 770 causes a corresponding rotation of the one or more centerless rims 764. The belt 770 may be constructed of any material, such as metal, rubber, composite materials, or other materials. Additionally, while described as a belt, any other comparable device such as a chain, etc. may be used.

Modifications, additions, or omissions may be made to the continuous track assembly 760 of FIGS. 11A-11C. For example, the continuous track assembly 760 may include more or fewer elements than those illustrated in FIGS. 11A-11C. For example, rather than a dual centerless rim arrangement, a single pivot point distal from a centerless rim may be used to facilitate use of a continuous track assembly, yielding a tear-drop shaped profile rather than a stadium shaped profile. Additionally or alternatively, the continuous track assembly 760 may include any of the modifications or variations described in the present disclosure.

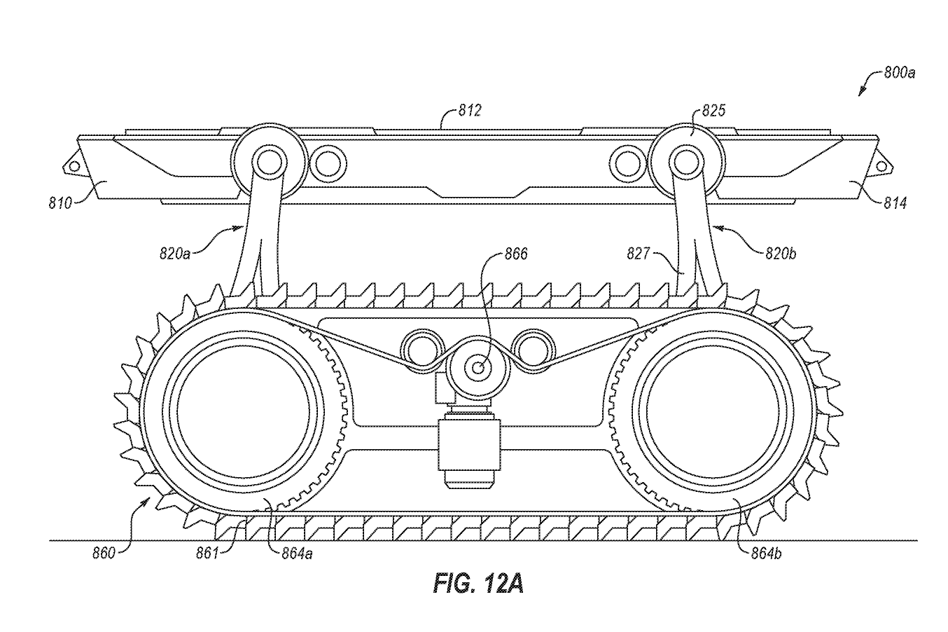

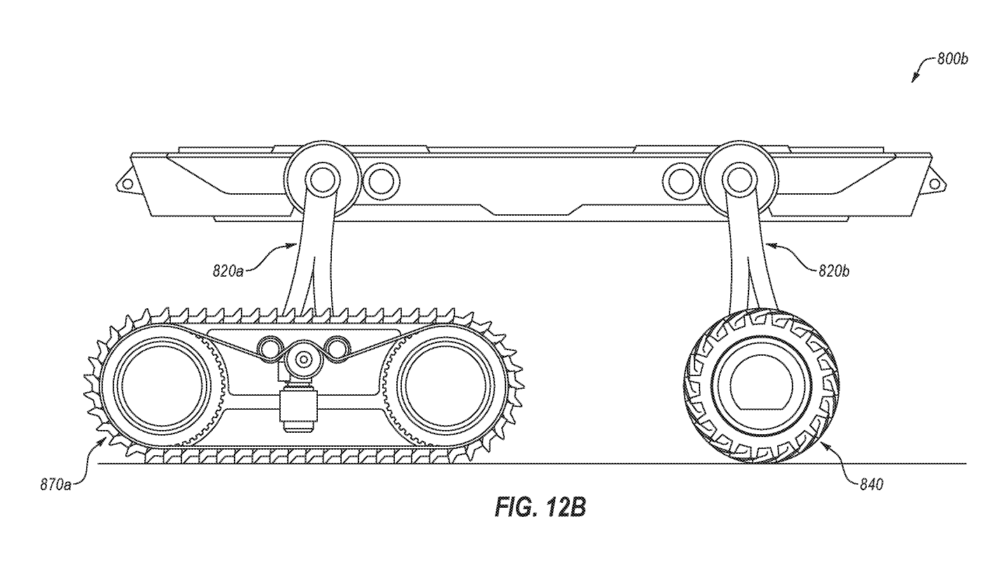

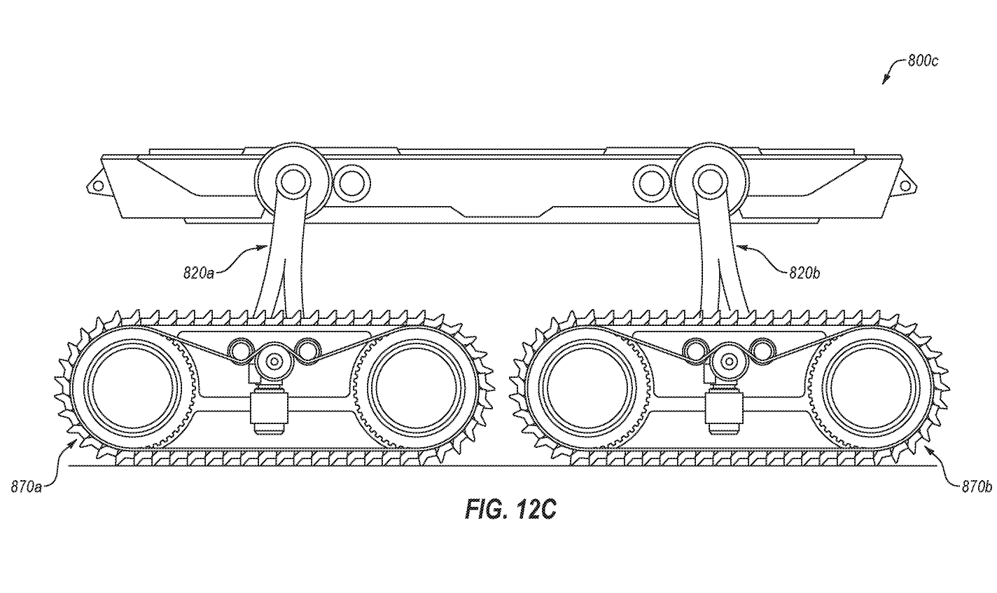

FIGS. 12A-12C illustrate various example ground vehicle assemblies 800a-800c. As illustrated in FIGS. 12A-12C, the ground vehicle assemblies 800a-800c may include a platform 810, one or more swing arm assemblies 820 (e.g., 820a and 820b), one or more centerless wheel assemblies 840, one or more continuous track assemblies 860/870 (e.g., 860, 870a and 870b), and/or a motor 866.

FIG. 12A illustrates the ground vehicle assembly 800a with the continuous track assembly 860. FIG. 12B illustrates the ground vehicle assembly 800b with the continuous track assembly 870a on one swing arm assembly 820a and the centerless wheel assembly 840 on another swing arm assembly 820b. FIG. 12C illustrates the ground vehicle assembly 800c with two separate continuous track assemblies 870 (e.g., the continuous track assemblies 870a and 870b) on the two swing arms.

As illustrated in FIGS. 12A-12C, the platform 810 may interface with the one or more swing arm assemblies 820. The one or more swing arm assemblies 820 may be coupled to the platform 810 in such a way that the swing arm assemblies 820 may rotate. A proximal end 825 of the one or more swing arm assemblies 820 may be coupled to a respective platform side 814 of the platform 810 in such a way that the swing arm assemblies 820 may rotate along a plane generally parallel to the respective platform side 814 of the platform 810. The one or more continuous track assemblies 860/870 may be coupled to a distal end 827 of the one or more swing arm assemblies 820.

The one or more swing arm assemblies 820 may include a device or component that may act to raise, lower, and/or stabilize the platform 810 relative to the terrain located below the ground vehicle assembly 800a-800c. The one or more swing arm assemblies 820 may function the same or in a way that is substantially similar to the one or more swing arm assemblies 120 as found in FIGS. 1-5 of the present disclosure. In addition, the one or more swing arm assemblies 820a and the one or more swing arm assemblies 820b may remain substantially parallel to one another on the same platform side 814 of the platform 810. In some embodiments, the one or more swing arm assemblies 820 may rotate until the one or more swing arm assemblies 820 may be substantially parallel to a plane generally defined by the top surface 812, effectively lowering the platform 810 to the ground or other surface. In addition, the platform 810 may remain substantially parallel to the ground during operation of the ground vehicle assembly 810 and while the platform 810 is being lowered to the ground or raised away from the ground or other surface. In some embodiments, the one or more swing arm assemblies 820 may rotate between the angles of about one hundred and eighty degrees and about three hundred and sixty degrees, or between the angles of about zero degrees and about negative one hundred and eighty degrees, as measured from the plane substantially parallel to the top surface 812.

In some embodiments, the pair of swing arm assemblies 820 may be coupled such that the one or more swing arm assemblies 820 remain substantially parallel to each other. In other embodiments, the movement of the pair of swing arm assemblies 820 may be limited by the distance between the one or more centerless rims 864 (e.g., 864a and 864b) and/or the length of the continuous track 861.

In some embodiments, as illustrated in FIG. 12A, the one or more swing arm assemblies 820a and the one or more swing arm assemblies 820b may be coupled with the same continuous track assembly 860. In these and other embodiments, the ground vehicle assembly 800a may include a pair of swing arm assemblies 820a/820b and a pair of continuous tracks 860, one on each side of the ground vehicle 800a.

In some embodiments, as illustrated in FIG. 12B, the swing arm assembly 820a of the ground vehicle assembly 800b may be coupled with the continuous track assembly 870a and the swing arm assembly 820b may be coupled with the centerless wheel assembly 840. In these and other embodiments, the ground vehicle assembly 800b may include a pair of the swing arm assemblies 820a, a pair of the swing arm assemblies 820b, a pair of the continuous track assemblies 870a, and a pair of the centerless wheel assemblies 840, with one set being on each side of the ground vehicle 860b.

In some embodiments, as illustrated in FIG. 12C, the swing arm assembly 820a and the swing arm assembly 820b may be coupled with the continuous track assemblies 870a and 870b, respectively. In these and other embodiments, comparable swing arm assemblies and/or continuous track assemblies may be disposed on the opposite side of the ground vehicle 800c.

The one or more continuous track assemblies 860/870 may include one or more half-track assemblies that, similar to the one or more continuous track assemblies 860/870, may allow the ground vehicle 800a-800c to contact and roll along the terrain encountered by the ground vehicle 800a-800c and may facilitate the directional control of the ground vehicle 800a-800c. The one or more half-track assemblies may be rotatably coupled with the one or more swing arm assemblies 820. The one or more half-track assemblies may include one or more centerless rims 864, a half-track belt, and one or more drive rollers. In some embodiments, the half-track belt may interface with the one or more drive rollers and the one or more centerless rims 864 in such a way that the rotation of the one or more drive rollers enacts a corresponding rotation of the one or more centerless rims 864. The one or more drive rollers may be driven by the motor 866. The one or more driver rollers may be rotatably coupled to the one or more continuous track assemblies 860/870. In addition, the one or more driver rollers may be rotatably coupled to the one or more swing arm assemblies 820.

Modifications, additions, or omissions may be made to the ground vehicles 800a-800c of FIGS. 12A-12C. For example, the ground vehicles 800a-800c may include more or fewer elements than those illustrated in FIGS. 12A-12C. For example, any combination and/or number of centerless wheel assemblies and continuous track assemblies and associated swing arm assemblies are contemplated within the scope of the present disclosure.

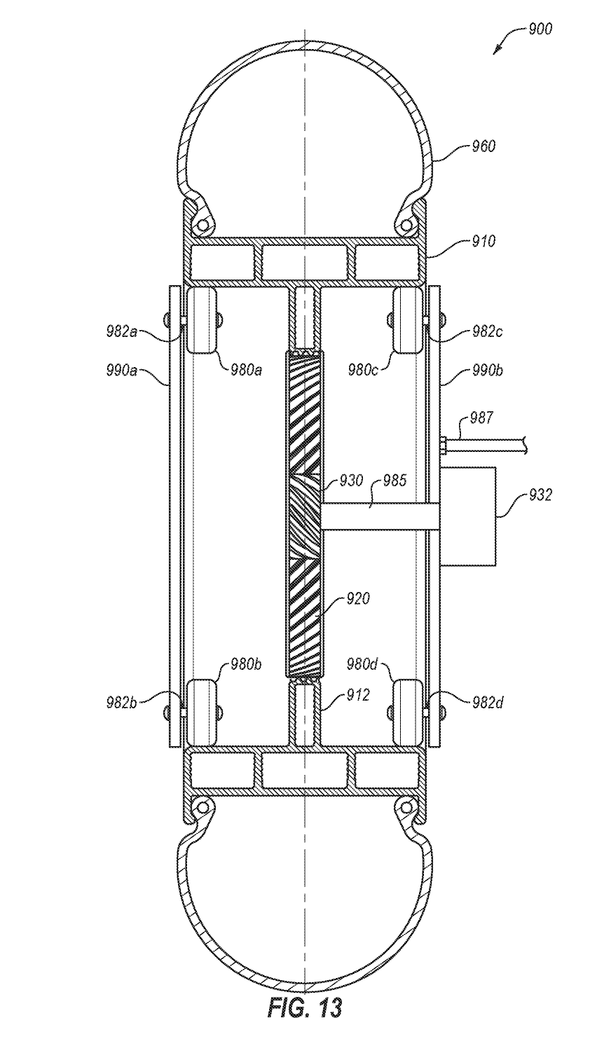

FIG. 13 illustrates a top cutaway view of an example centerless wheel assembly 900. As illustrated in FIG. 13, the centerless wheel assembly 900 may include a centerless rim 910 and a ring gear 920 coupled to the centerless rim 910. The ring gear 920 may interface with a drive gear 930. The drive gear 930 may rotate and cause the ring gear 920 to rotate.

The ring gear 920 may interface with the drive gear 930 such that as the drive gear 930 is rotated, the drive gear 930 causes a corresponding rotation of the ring gear 920. The rotation of the ring gear 920 may cause a corresponding rotation of the centerless rim 910 to which the ring gear 920 may be coupled. The ring gear 920 may include teeth. Additionally or alternatively, the ring gear 920 may include sprockets, spurs, etc., or any other suitable element. In some embodiments, the teeth may run along the inner diameter of the ring gear 920. The ring gear 920 and/or the teeth may be implemented as a helical gear (left- or right-handed), a double helical gear, a spur gear, an internal ring gear, a face gear, a planetary gear, etc. In these and other embodiments, the teeth of the ring gear 920 may interface with teeth of the drive gear 930. The teeth of the drive gear and/or the drive gear 930 may be implemented in a similar manner as that described for the teeth of the ring gear and/or the ring gear 920, but may be implemented in a different manner.

The drive gear 930 may be coupled to and driven by an input shaft 985. The input shaft 985 may be coupled to and/or driven any type of drive mechanism. For example, the drive shaft 985 may be coupled directly to a motor 932, to a drivetrain or other gearing to a motor, to a half-shaft of an automobile, etc. The motor 932 may be comparable to or similar to the motor 766 of FIGS. 11A-11C, the motor 866 of FIGS. 12A-C, etc. The rotation of the ring gear 920 and/or the drive gear 930 may cause a corresponding rotation of the centerless rim 910. For example, the rotation of the drive gear 930 may cause a corresponding rotation of the drive gear 920, which then may cause a corresponding rotation of the centerless rim 910.

The centerless rim 910 may include any shape or profile. The centerless rim 910 may include an inner profile such that one or more roller guides 980 (such as the one or more roller guides 980a-d) may roll along the centerless rim 910. The centerless rim 910 may include an outer profile such that a tire 960 may be coupled to the centerless rim 910. In some embodiments, centerless rim 910 may be coupled to a tire 960. The centerless rim 910 may also include a rail 912 that may function to maintain contact between the one or more roller guides 980 and the centerless rim 910 and/or may otherwise prevent the one or more roller guides 980 from derailing.

The one or more roller guides 980 may function to maintain a drive gear 930 and a ring gear 920 in engaged such that the drive gear 930 may drive the ring gear 920. The one or more roller guides 980 may be coupled to one or more exoskeleton plates 990 (such as the one or more exoskeleton plates 990a and 990b) via one or more roller guide shaft 982 (such the one or more roller guide shafts 982a-d). For example, the one or more roller guides 980a may be coupled to the one or more exoskeleton plate 990a via the one or more roller guide shafts 982. The one or more roller guide shafts 982 may be coupled to one or more exoskeleton plates 990 and may bridge a gap between the one or more exoskeleton plates. The one or more roller guide shafts 982 may be coupled to a single exoskeleton plate of the one or more exoskeleton plates 990 (e.g., the one or more exoskeleton plates 990a) rather than bridging between both the one or more exoskeleton plates 990a-b. For example, one or more roller guide shafts 982 may be cantilevered from the one or more exoskeleton plates 990. In operation, the one or more roller guide shafts 982 may function in a similar manner to an axle or bridging shaft that spans between the one or more exoskeleton plates 990. For example, in these and other embodiments, the one or more roller guides 980a may be configured to roll freely along the one or more roller guide shafts 982a.

In some embodiments, the one or more exoskeleton plates 990 may be coupled to a ground vehicle via a coupling arm 987. For example, the one or more exoskeleton plates 990b may be coupled to one or more swing arm assemblies of the ground vehicle via the coupling arm 987. In some embodiments, the coupling arm 987 may be coupled to the exoskeleton plate via a geared mechanism coupled to a motor that permits the coupling arm 987 to change its orientation relative to the exoskeleton plate 990b. For example, the motor and/or gear assembly may permit modification of the vertical orientation of the centerless wheel assembly 900 (e.g., camber of the wheel) and/or horizontal orientation of the centerless wheel assembly 900 (e.g., the direction the wheel is turned relative to a vehicle).

Modifications, additions, or omissions may be made to the centerless wheel assembly 900 of FIG. 13. For example, the centerless wheel assembly 900 may include more or fewer elements than those illustrated in FIG. 13.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” the term “containing” should be interpreted as “containing, but not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

The drawings included herein are for example purposes only, and may not be drawn to scale. For example, various components may be omitted or additional components may be included. Additionally, the various components of the drawings may be oriented in different directions or coupled in various manners and be within the scope of the present disclosure.

All examples and conditional language recited in the present disclosure are intended for pedagogical objects to aid the reader in understanding the disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A ground vehicle comprising:
a platform;
a first swing arm assembly rotatably coupled to a first side of the platform and comprising a proximal end of the first swing arm assembly and a distal end of the first swing arm assembly, the first swing arm assembly configured to:
move from a first position of the first swing arm assembly to a second position of the first swing arm assembly by rotating the first swing arm assembly about a first pivot point on the first side of the platform, the first pivot point corresponding to where the proximal end of the first swing arm assembly couples to the first side of the platform; and
move from either the first position of the first swing arm assembly or the second position of the first swing arm assembly to a third position of the first swing arm assembly by actuating the first swing arm assembly from the first pivot point such that the distal end of the first swing arm assembly moves away from the platform to broaden a wheelbase of the ground vehicle; and
a first centerless wheel assembly rotatably coupled to the distal end of the first swing arm assembly, the first centerless wheel assembly configured to roll along a surface and maintain a first vertical orientation to the surface in the first position of the first swing arm assembly, the second position of the first swing arm assembly, and the third position of the first swing arm assembly.

2. The ground vehicle of claim 1, wherein the first swing arm assembly is configured to rotate about the first pivot point such the first swing arm assembly rotates in a first plane that is parallel to a second plane formed by the first side of the platform.

3. The ground vehicle of claim 2, wherein the rotation of the first swing arm assembly about the proximal end of the first swing arm assembly and in the first plane changes a first distance of the platform from the surface.

4. The ground vehicle of claim 2, wherein the first swing arm assembly rotates about the first pivot point such that the distal end of the first swing arm assembly extends above a fifth plane formed by a top surface of the platform.

5. The ground vehicle of claim 1, further comprising:
a second swing arm assembly rotatably coupled to a second side of the platform and comprising a proximal end of the second swing arm assembly and a distal end of the second swing arm assembly, the second swing arm assembly configured to:
move from a first position of the second swing arm assembly to a second position of the second swing arm assembly by rotating the second swing arm assembly about a second pivot point on the second side of the platform, the second pivot point corresponding to where the proximal end of the second swing arm assembly couples to the second side of the platform; and
move from either the first position of the second swing arm assembly or the second position of the second swing arm assembly to a third position of the second swing arm assembly by actuating the second swing arm assembly from the second pivot point such that the distal end of the second swing arm assembly moves away from the platform to broaden the wheelbase of the ground vehicle; and
a second centerless wheel assembly rotatably coupled to the distal end of the second swing arm assembly, the second centerless wheel assembly configured to roll along the surface and maintain a second vertical orientation to the surface in the first position of the second swing arm assembly, the second position of the second swing arm assembly, and the third position of the second swing arm assembly.

6. The ground vehicle of claim 5, wherein the second swing arm assembly is configured to rotate about the second pivot point such the second swing arm assembly rotates in a third plane that is parallel to a fourth plane formed by the first side of the platform.

7. The ground vehicle of claim 5, wherein the movement of the second swing arm assembly from either the first position of the second swing arm assembly or the second position of the second swing arm assembly to the third position of the second swing arm assembly changes a distance between the first centerless wheel assembly and the second centerless wheel assembly.

8. The ground vehicle of claim 5, wherein the first swing arm assembly and the second swing arm assembly are configured to move independently of each other.

9. The ground vehicle of claim 5, wherein the first swing arm assembly and the second swing arm assembly are configured to support the platform and to maintain a top surface of the platform substantially level.

10. The ground vehicle of claim 5, wherein the first swing arm assembly and the second swing arm assembly are configured to lower the platform toward the surface.

11. The ground vehicle of claim 5, wherein the first swing arm assembly and the second swing arm assembly are configured to lower the platform toward the surface while maintaining the platform in a substantially level orientation.

12. The ground vehicle of claim 5, wherein the first swing arm assembly and the second swing arm assembly are configured to raise the platform above one or more obstructions on the surface while remaining substantially level.

13. The ground vehicle of claim 5, further comprising:
a third swing arm assembly rotatably coupled to the first side of the platform and comprising a proximal end of the third swing arm assembly and a distal end of the third swing arm assembly, the third swing arm assembly configured to:
move from a first position of the third swing arm assembly to a second position of the third swing arm assembly by rotating the third swing arm assembly about a third pivot point on the first side of the platform, the third pivot point corresponding to where the proximal end of the third swing arm assembly couples to the first side of the platform; and
move from either the first position of the third swing arm assembly or the second position of the third swing arm assembly to a third position of the third swing arm assembly by actuating the third swing arm assembly from the third pivot point such that the distal end of the third swing arm assembly moves away from the platform to broaden the wheelbase of the ground vehicle;
a third centerless wheel assembly rotatably coupled to the distal end of the third swing arm assembly, the third centerless wheel assembly configured to roll along the surface and maintain a third vertical orientation to the surface in the first position of the third swing arm assembly, the second position of the third swing arm assembly, and the third position of the third swing arm assembly;
a fourth swing arm assembly rotatably coupled to the second side of the platform and comprising a proximal end of the fourth swing arm assembly and a distal end of the fourth swing arm assembly, the fourth swing arm assembly configured to:
move from a first position of the fourth swing arm assembly to a second position of the fourth swing arm assembly by rotating the fourth swing arm assembly about a fourth pivot point on the second side of the platform, the fourth pivot point corresponding to where the proximal end of the fourth swing arm assembly couples to the second side of the platform; and
move from either the first position of the fourth swing arm assembly or the second position of the fourth swing arm assembly to a third position of the fourth swing arm assembly by actuating the fourth swing arm from the fourth pivot point such that the distal end of the fourth swing arm assembly moves away from the platform to broaden the wheelbase of the ground vehicle; and
a fourth centerless wheel assembly rotatably coupled to the distal end of the fourth swing arm assembly, the fourth centerless wheel assembly configured to roll along the surface and maintain a fourth vertical orientation to the surface in the first position of the fourth swing arm assembly, the second position of the fourth swing arm assembly, and the third position of the fourth swing arm assembly.

14. The ground vehicle of claim 13, further comprising a continuous track assembly configured to couple the first centerless wheel assembly and the third centerless wheel assembly such that the rotation of the first centerless wheel assembly causes a corresponding rotation of the third centerless wheel assembly.

15. The ground vehicle of claim 13, further comprising:
a fifth centerless wheel assembly rotatably coupled to the distal end of the first swing arm assembly, the fifth centerless wheel assembly configured to roll along the surface and maintain a fifth vertical orientation to the surface in the first position of the first swing arm assembly, the second position of the first swing arm assembly, and the third position of the first swing arm assembly; and
a continuous track assembly configured to couple the first centerless wheel assembly and the fifth centerless wheel assembly such that the rotation of the first centerless wheel assembly causes a corresponding rotation of the fifth centerless wheel assembly.

16. The ground vehicle of claim 1, wherein the first centerless wheel assembly comprises:
a centerless rim including a first center point laying in a sixth plane generally defined by the centerless rim;
a roller guide with a profile that matches a profile of the centerless rim such that the roller guide rolls along an inner circumference of the centerless rim as the centerless rim rotates; and
an exoskeleton plate supporting the roller guide and remaining stationary relative to the centerless rim as the centerless rim rotates, the exoskeleton plate coupling to the distal end of the first swing arm assembly.

17. The ground vehicle of claim 1, further comprising a linear actuator coupled to the first swing arm assembly and configured to actuate the first swing arm assembly from the first position of the first swing arm assembly or the second position of the first swing arm assembly to the third position of the first swing arm assembly.

18. The ground vehicle of claim 1, wherein the first swing arm assembly includes at least one of gears, belts, hydraulics, or pneumatics to move the first swing arm assembly from the first position of the first swing arm assembly to the second position of the first swing arm assembly and to move the first swing arm assembly from the first position of the first swing arm assembly or the second position of the first swing arm assembly to the third position of the first swing arm assembly.

19. A system of vehicles comprising:
a first ground vehicle comprising:
a platform;
a first swing arm assembly rotatably coupled to a first side of the platform and comprising a proximal end of the first swing arm assembly and a distal end of the first swing arm assembly, the first swing arm assembly configured to:
move from a first position of the first swing arm assembly to a second position of the first swing arm assembly by rotating the first swing arm assembly about a first pivot point on the first side of the platform, the first pivot point corresponding to where the proximal end of the first swing arm assembly couples to the first side of the platform; and
move from either the first position of the first swing arm assembly or the second position of the first swing arm assembly to a third position of the first swing arm assembly by actuating the first swing arm assembly from the first pivot point such that the distal end of the first swing arm assembly moves away from the platform to broaden a wheelbase of the ground vehicle; and
a first centerless wheel assembly rotatably coupled to the distal end of the first swing arm assembly, the first centerless wheel assembly configured to roll along a surface and maintain a first vertical orientation to the surface in the first position of the first swing arm assembly, the second position of the first swing arm assembly, and the third position of the first swing arm assembly; and
a second vehicle;
wherein the first ground vehicle and the second vehicle are communicatively coupled.

20. The system of vehicles of claim 19, wherein the first ground vehicle may be configured in a first planar orientation and the second vehicle may be configured in a second planar orientation and the second vehicle may be stacked on top of the first ground vehicle.
